(19) United States
(12) Patent Application Publication
(10) Pub. No.: US 2010/0012200 A1
(43) Pub. Date: Jan. 21, 2010

(54) CONTROL SYSTEM FOR A HYDRAULIC ELEMENT

(75) Inventor: Adolf Tretsch, Stockach (DE)

Correspondence Address: BACHMAN & LAPOINTE, P.C., 900 CHAPEL STREET, SUITE 1201, NEW HAVEN, CT, 06510, US

(73) Assignee: AROS HYDRAULIK GMBH, Memmingen (DE)

(21) Appl. No.: 12/375,043

(22) PCT Filed: Jul. 25, 2007
(86) PCT No.: PCT/EP2007/006604

§ 371 Date: Jan. 28, 2009

(30) Foreign Application Priority Data
Jul. 25, 2006 (DE) 10 2006 034 864.8
Jul. 25, 2006 (DE) 10 2006 034 867.2
Dec. 8, 2006 (DE) 10 2006 058 271.3
Jan. 15, 2007 (DE) 10 2007 002 866.2
Feb. 8, 2007 (DE) 10 2007 007 054.5

(51) Int. Cl. F16K 17/00

(52) U.S. Cl. 137/511

(57) ABSTRACT

In the case of a control system for a hydraulic element (14) which, under the pressure of hydraulic fluid in a locking pressure space (16) on one side of the hydraulic element (14) enters into an unlocking pressure space (13) on the other side of the hydraulic element (14), wherein the two pressure spaces (13, 16) are connected via a respective line (19) and (20) to the same main line (3, 4), a pressure-regulating valve (18) is to be connected into the line (19) to the unlocking pressure space (13), preventing the fluid from flowing back out of the unlocking pressure space (13). Furthermore, a pressure-compensating valve (21) is to be connected into the line (20) to the locking pressure space (16).

### BACKGROUND OF THE INVENTION

The invention relates to a control system for a hydraulic element, which moves under the pressure of pressure fluid in a locking pressure area on one side of the hydraulic element into an unlocking pressure area on the other side of the hydraulic element, with both pressure areas being connected via a respective line to the same main line.

There are a multiplicity of control systems for hydraulic elements. Just by way of example, reference is made to working cylinders which are intended to be capable of being locked in a specific position. For example, DE 41 41 460 C2 discloses a working cylinder which is operated by a pressure medium and in which a spindle which can rotate engages in a piston rod tube. When the corresponding piston, which is associated with the piston rod tube, is subjected to pressure, the spindle also rotates, such that the piston rod tube can be moved axially.

All of these working cylinders are subject to the problem that, if the pressure in the actual main pressure area in which the piston has pressure applied to it collapses, for example by sealing collars fracturing, the piston is set in motion automatically under the pressure of the load or else or under attention, with the external thread on the spindle running off the internal thread of the piston rod tube. In order to prevent this, the aim is to lock the working cylinder, that is to say to stop the movement of the piston. According to EP 1 538 344 A2 this happens as a result of a locking body, which is subject to a spring force from a spring, engaging in a locking hole in the spindle and thus interrupting the rotation of the spindle. If unlocking takes place, the locking body is moved with the aid of a fluid working medium against the spring force of the spring from the locked position to an unlocked position, in which the spindle can rotate about its rotation axis. However, the problem with this arrangement is to control the pressure medium supply to the pressure chambers and to the unlocking pressure chamber. Furthermore, the control process is extremely problematic when disturbances occur in the fluid supply and return system.

However, these problems apply not only to lockable working cylinders but to all hydraulic systems in which a hydraulic element can be moved between two pressure areas, but enters one of the pressure areas in a secured manner in the event of a disturbance or the like, with both pressure areas being connected to the same main line.

The object of the present invention is to develop a control system of the abovementioned type which “in a thinking sense” carries out the unlocking and locking of the hydraulic elements.

### SUMMARY OF THE INVENTION

The object is achieved on the one hand by connecting a pressure control valve, which prevents fluid from flowing back from the unlocking pressure area, in the line to the unlocking pressure area.

The pressure control valve guarantees that, when a main valve is closed, the pressure in the line to the unlocking pressure area is always lower by a desired extent (for example 2 bar) than the pressure in the line to the locking pressure area.

Where the expression pressure control valve is used in the present application, then this covers any element which suppresses a return flow of the fluid. The hydraulic element mentioned above may likewise have any desired form and configuration.

The second refinement of the control system according to the invention, for which protection is also separately sought, provides for a pressure equalizing valve to be connected in the line to the locking pressure area. This is provided in a hydraulic system which operates both with and without a pressure control valve. In particular, this pressure equalizing valve counteracts disturbances. It is designed especially for this purpose. On the one hand, a sliding piston which is connected to the fluid supply system is located in an axial stepped hole in the pressure equalizing valve. For this purpose, a T-line is formed in the sliding piston and opens radially toward the inner surface of the stepped hole, to be precise preferably into an annular channel. Following the annular channel, the sliding piston no longer rests closely on the inner surface of the stepped hole, but forms an annular gap there through which pressure fluid can flow into a flow chamber and further into a line to the locking pressure area, behind the hydraulic element.

Furthermore, the sliding piston presses on a sphere which is subject to the pressure of a spring. The sliding piston can push the sphere into a spherical seat in which the sphere is automatically leveled. This interrupts the flow of pressure medium through the line to the locking pressure area downstream from the hydraulic element, and the pressure in the locking pressure area is maintained, thus reliably preventing unlocking of the hydraulic element.

In a further exemplary embodiment of the invention, the sliding piston is in the form of a restricted-orifice piston. In the same way as the sliding piston described above, this piston also slides in the stepped hole, but it has a restricted orifice in the interior, by means of which the flow opening is considerably constricted. The flow is therefore independent of any change in the temperature or viscosity of the pressure medium. The restricted-orifice piston interacts with the sphere in the same manner, however, forming an annular edge toward the sphere, in which indentations are formed, such that pressure medium can pass through into the downstream line, between the sphere and the restricted-orifice piston.

The pressure control valve according to the invention upstream of the unlocking pressure area of the hydraulic element is designed such that, when a fluid pressure builds up in the fluid system, it allows pressure medium to pass to the unlocking pressure area before further pressure areas, which are fed from the main line, have pressure applied to them. For this purpose, it has been found to be advantageous for the pressure control valve to be adjustable. Furthermore, a load-holding valve is connected upstream of the further pressure area and has an associated non-return valve in a bypass which, in any case, is designed to be higher than the pressure control valve upstream of the unlocking pressure area. This means that, up to a certain magnitude of the pressure in the fluid supply system, only pressure fluid flows to the unlocking pressure area, which results in the hydraulic element being moved first of all. Only when the pressure in the fluid system exceeds a specific value does pressure fluid also flow into the pressure area via the non-return valve in the bypass of the load-holding valve.

If pressure medium flows back out of the pressure chamber in the event of a leakage in the load-holding valve or the non-return valve associated with the load-holding valve in the bypass, then, if the system is otherwise blocked, it can on the one hand flow through the pressure control valve into the unlocking pressure area upstream of the hydraulic element, but on the other hand can also flow through the pressure equalizing valve and the annular area into the locking pressure area downstream from the hydraulic element. When the main valve is closed, the pressure in the locking pressure area downstream from the hydraulic element is at least 2 bar higher than the pressure in the unlocking pressure area upstream of the hydraulic element. Since a spring is also located in the locking pressure area and is supported against the hydraulic element, the hydraulic element is always held in the locked position.

If, in contrast and by way of example, the load-holding valve or else the non-return valve associated with it fails entirely, then it is possible for the pressure in the return-flow line to rise suddenly. In this case, the pressure equalizing valve is likewise closed suddenly, since the amount of pressure fluid through the T-line presses the sliding piston downward, because of the very narrow annular gap, and presses the sphere into its spherical seat. This results in a pumping effect of pressure fluid into the locking pressure area downstream from the hydraulic element, such that a rise of pressure in the unlocking pressure area upstream of the hydraulic element also does not lead to the hydraulic element being moved from its locked position. The pressure in the locking pressure area downstream from the hydraulic element when the main valve is closed is at least 2 bar higher than the pressure in the unlocking pressure area upstream of the hydraulic element.

If a plurality of pressure areas are provided, a dedicated load-holding valve with a non-return valve in the bypass is preferably, of course, provided for each pressure area, with the systems being connected to one another by changeover valves, from which the line to the unlocking pressure area also branches off upstream of the hydraulic element, into which line the adjustable pressure control valve is inserted. In this case, of course, the controllers for the load-holding valves are always also connected to the respective main line which leads to the respective other load-holding valve, in order that the respective other load-holding valve is opened, in order to allow pressure medium to flow back out of the pressure area to which the pressure medium is not applied.

The pressure equalizing valve is particularly worthwhile when a valve which can be shut off is provided as the main valve for the supply of the entire fluid supply system. However, it is also feasible to arrange a valve which allows the pressure medium to flow back from both lines at the same time, thus allowing pressure equalization through this valve in the event of slight leakages without the pressure equalizing valve mentioned above being operated. The pressure equalizing valve should nevertheless also in any case be provided there since, in the event of a sudden rise in the pressure in the system, it in any case supplies the locking pressure area downstream from the hydraulic element, when the main valve is closed, with a pressure which is 2 bar higher than that in the unlocking area upstream of the hydraulic element, as a result of which it is impossible for the hydraulic element to become unlocked, in any case.

In a further exemplary embodiment of a hydraulic system according to the invention, the pressure control valve in the line to the pressure area upstream of the blocking bolt is omitted. However, the pressure equalizing valve is still important. Furthermore, the response capability of the non-return valves around the load-holding valves is reduced significantly, virtually to zero, and additional restricted orifices are installed in the main lines. This results in a system which is independent of any change in the temperature or viscosity of the pressure medium and ensures that the piston of the lockable working cylinder is guided between two pressure cushions in the corresponding pressure areas. A further major advantage is that, as a result of the omission of the pressure limiting of the non-return valves around the load-holding valves, the working cylinder can cope with considerably higher loads.

If a pressure builds up in the respective main line, then pressure medium flows into the corresponding pressure area of the working cylinder. The piston of the working cylinder cannot move, however, since the respective other load-holding valve is blocked. This means that a considerably higher pressure is built up both in the supply line to the pressure area of the working cylinder and in the supply line to the pressure area upstream of the blocking bolt, and this leads to closing of the pressure equalizing valve. After this, the pressure in the pressure area upstream of the blocking bolt just needs to be increased further until the force of the helical spring behind the blocking bolt is overcome. Any correspondingly present pressure medium is forced back via non-return valves.

The blocking bolt now unlocks. If the pressure is now increased further, the other load-holding valve responds, as a result of which the pressure area which was previously closed can empty. Only then can the piston of the working cylinder now also move.

If a disturbance occurs, then the pressure equalizing valve and restricted orifices that are arranged according to the invention ensure that the blocking bolt always operates as desired.

### BRIEF DESCRIPTION OF THE DRAWINGS

Further advantages, features and details of the invention will become evident from the following description of preferred exemplary embodiments and with reference to the drawing, in which:

FIG. 1 shows a block-diagram illustration of a control system for a lockable working cylinder, which is illustrated schematically in the form of a longitudinal section;

FIG. 2 shows a block-diagram illustration of a further main valve for use in a control system as shown in FIG. 1;

FIG. 3 shows a cross section, illustrated enlarged, from a control block in the area of a pressure equalizing valve;

FIG. 4 shows an enlarged cross section through a restricted-orifice piston;

FIG. 5 shows a block-diagram illustration of a further exemplary embodiment of a control system for a lockable working cylinder, which is illustrated schematically in the form of a longitudinal section.

### DETAILED DESCRIPTION

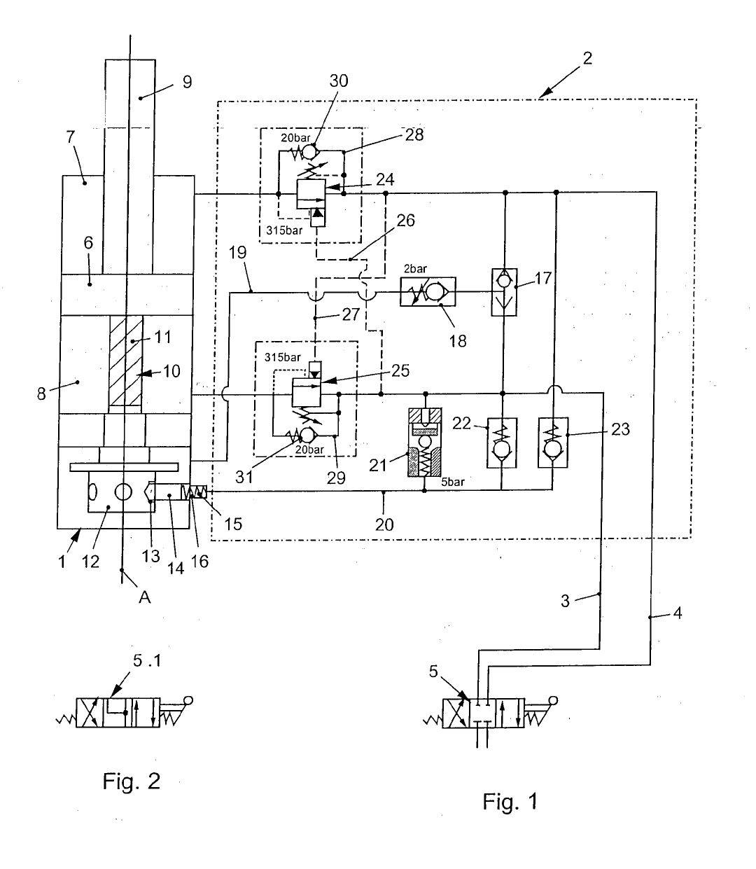

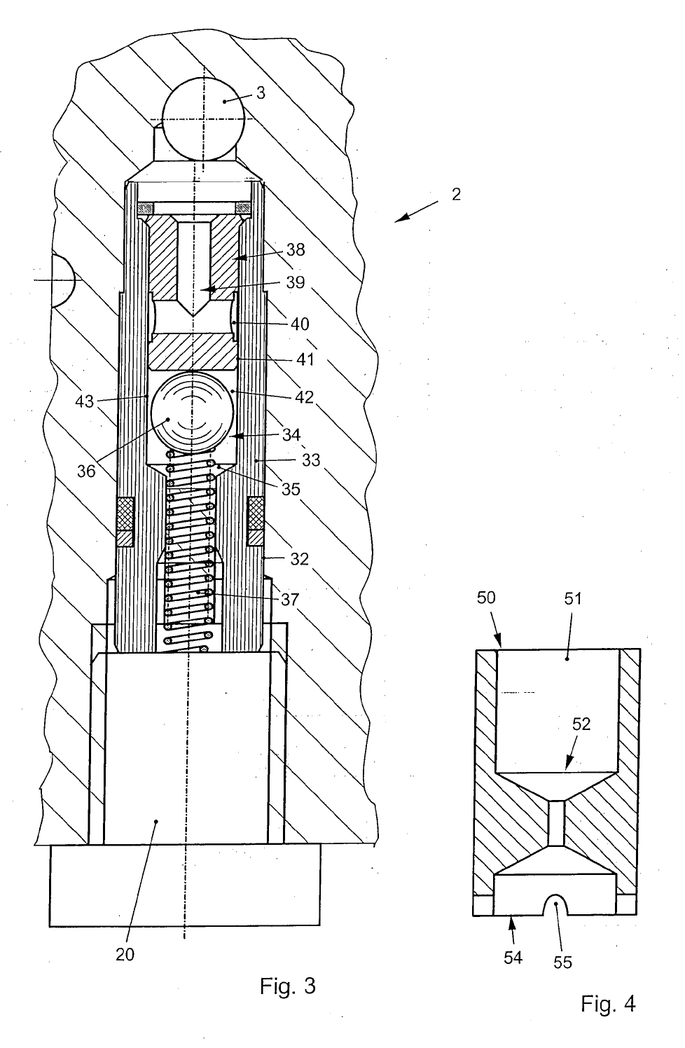

As shown in FIG. 1, a lockable working cylinder 1 has an associated control block 2, which is illustrated by dashed-dotted lines. The main lines 3 and 4 lead from the control block 2 to a main valve 5 which is connected to a pressure source, which is not shown in any more detail, for a fluid. Both a gas and a liquid, in particular hydraulic fluid, may be used as the pressure source.

In order to explain the lockable working cylinder in more detail, reference is made in particular to P 10 2005 015 059.4. A piston 6 which can slide is located between two pressure areas 7 and 8 in this working cylinder 1. A piston rod 9, which leads to the exterior, is connected to this piston 6. A spindle 10 is seated in the piston 6 and its external thread 11 interacts with a corresponding internal thread in the spindle 6 of the piston rod 9, such that this spindle 10 is rotated about its longitudinal axis A. During the process, the spindle 10 drives a partial disk 12 which has a plurality of radially arranged unlocking pressure areas 13. One (or more) blocking bolt or bolts 14 can move into these unlocking pressure areas 13, is or are guided radially and is or are subject to the pressure of a helical spring 15, with this helical spring 15 being arranged in a locking pressure area 16 downstream from the blocking bolt 14.

The main line 4 mentioned above leads from the main valve 5 to the pressure area 7, such that, when the pressure area 7 is being filled, the piston rod 9 is drawn in. The main line 3 leads from the main valve 5 to the pressure area 8, in such a way that the piston rod 9 is ejected or forced out when the pressure area 8 is being filled.

Furthermore, both main lines 3 and 4 are connected via a changeover valve 17 and via an adjustable pressure control valve 18 in a line 19.

The locking pressure area 16 is connected via a further line 20 on the one hand via a pressure equalizing valve 21 to the main line 3 and on the other hand via a respective non-return valve 22 and 23 to the respective main line 3 or the main line 4.

A load-holding valve 24 or 25, respectively, is connected both in the main line 3 and in the main line 4, upstream of the connection to the corresponding respective pressure areas 7 and 8. Each load-holding valve 24 and 25 is adjustable, and is connected via a respective dashed line 26 or 27 to the respective main line 3 or 4 upstream of the respective other load-holding valve 25 or 24. Furthermore, each respective load-holding valve 24 or 25 has a respective bypass 28 or 29, in which a respective non-return valve 30 or 31 is connected.

A control system such as this allows the following options and functions, in which case the interaction of the working cylinder and control system can be referred to as a “thinking cylinder”:

### Normal Operation

Understandably, before the piston 6 is moved, it must be unlocked, which means that the blocking bolt 14 must leave the unlocking pressure area. How does the cylinder now know that this must be done before a pressure builds up in the pressure areas 7 or 8 without a specific sensor observing this blocking bolt 14?

For this purpose, the non-return valves 30 and 31 are matched to the adjustable pressure control valve 18. If, for example, as is shown in FIG. 1, the pressure area 8 is intended to be filled with a pressure fluid, which means that the working cylinder acts in a pushing manner, the changeover valve 17 is in the position shown and the pressure fluid can flow via the pressure control valve 18, which is set to 2 bar, and the line 19 into the unlocking pressure area 13, until a pressure of 20 bar is reached there, at which, however, the blocking bolt 14 is finally forced out of the unlocking pressure area 13. The non-return valve 31 in the bypass 29 of the load-holding valve 25 cannot be overcome, and the pressure area 8 thus cannot be filled, until the pressure in the system has built up to 20 bar.

If, in contrast, the aim is to fill the pressure area 7 and thus to provide the working cylinder with a pulling action, then pressure fluid is supplied into the main line 4 by moving the main valve 5 to the right. In consequence, the changeover valve 17 switches over, so that the access to the main line 3 is now blocked. In contrast, the main line 4 is connected via the adjustable pressure control valve 18 to the unlocking pressure area 13 upstream of the blocking bolt 14. Furthermore, signaling takes place via the line 27 to the load-holding valve 25 that opens it, in order that pressure fluid can escape from the pressure area 8 via the main line 3 and the main valve 5.

In this case as well, pressure fluid first of all flows via the adjustable pressure control valve 18, since the non-return valve 30 in the bypass 28 of the load-holding valve 24 opens only when a pressure of 20 bar has built up in the system. However, in this case, the blocking bolt 14 is also unlocked at 20 bar.

For locking, the main valve 5 is switched to the mid-position in which the two main lines 3 and 4 have no pressure in them. Under the pressure of the helical spring 15, the blocking bolt 14 is pushed into the unlocking pressure area 13. This prevents rotation of the spindle 10, as a result of which the piston 6 remains secured in this position.

### Disturbances

Disturbances are significant only if they would lead to inadvertent unlocking of the blocking bolt 14. This would be the case, for example, if a fault were to occur on the load-holding valve 24 or 25, particularly in the case of the non-return valve 30 or 31, for example if the valves jam or the springs break. In this case, a pressure could build up in the respective system, with pressure fluid flowing via the adjustable pressure control valve 18 into the unlocking pressure area 13, and this would unlock the blocking bolt 14. On the one hand, this can be prevented by choosing a main valve 5 as is illustrated in FIG. 2. When this main valve is, the main lines 3 and 4 are not blocked in the mid-position, but open for a return flow. This means that no pressure which leads to unlocking of the blocking bolt 14 can build up in the entire system.

In many cases, however, it is desirable to also use a main valve 5 which could be used in a different way, as shown in FIG. 1. In this case, it is particularly desirable to use the pressure equalizing valve 21 according to the invention. A hole 32, in which an insert 33 is located, is provided for this pressure equalizing valve 21 between the main line 3 and the line 20 in the control block 2. A stepped hole 34, in which a spherical seat 35 for a sphere 36 is formed, passes through this insert 33. The sphere 36 is supported against a helical spring 37, in such a way that it is raised off the spherical seat 35.

On the other hand, a sliding piston 38 presses on the sphere 36 and has a T-line 39 passing through it, which is connected to the main line 3. The T-line 39 opens into an annular channel 40 which is connected to a flow chamber 42 via an annular gap 41. In order to form the annular gap 41, the sliding piston 38 in this area maintains a short distance from an inner surface 43 of the stepped hole 34. The stress on the helical spring 37 is set such that the pressure equalizing valve 21 in the main line closes at a pressure of 5 bar. In this case, the interaction of the sphere 36 with the spherical seat 35 has the particular advantage of increased accuracy in comparison to a conical valve, since the sphere, which is pushed by the sliding piston 38, can level itself in the spherical seat 35, thus compensating for any possible inaccuracies.

If the load-holding valve 25 or the non-return valve 31 now fails, then, in the event of a slow leakage, pressure fluid flows through the T-line 39, the annular channel 40 and the annular gap 41, and past the sphere 36 into the line 20, and into the locking pressure area 16. Even if the leakage were to exceed a pressure of 2 bar, pressure equalization takes place there with a pressure difference of 2 bar in the system between the unlocking pressure area 13, the line 19, the pressure control valve 18, the main line 3, the pressure equalizing valve 21, the line 20 and the locking pressure area 16. In this case, the force of the helical spring 15 and the force of the pressure, which is higher by 2 bar, predominate, and hold the blocking bolt 14 in the locked position.

If the load-holding valve 25 or the non-return valve 31 were to fail completely, then a pressure could also be increased suddenly, then overcoming the pressure control valve 18, although sufficient pressure fluid is not passed through the pressure equalizing valve 21 to produce an equilibrium. In this case, however, the sudden pressure rise results in the sliding piston 38 being moved downward, as a result of which the sphere 36 is pressed onto the seat 35 and pressure fluid is pumped through the line 20 into the locking pressure area 16. This pumping effect in any case overcomes the pressure of the pressure fluid through the pressure control valve 18 and the line 19 into the unlocking pressure area 13, so that the blocking bolt 14 remains in the locked position.

As a further malfunction, it would be possible for the helical spring 15 to break before the blocking bolt 14. In this case as well, the full system pressure occurs in the locking pressure area 16 since there is nothing to prevent flow through the pressure equalizing valve 21. In contrast, the pressure control valve 18 in the line 19 results in a pressure loss of 2 bar, so that a system pressure reduced by 2 bar is created in the unlocking pressure area 13. The blocking bolt 14 thus remains in the locked position or, if the helical spring is broken and the main valve is closed, is pushed to the locked position by the pressure, which is higher by 2 bar, in the locking pressure area 16.

It is, of course, also feasible for a second pressure equalizing valve to be associated with the load-holding valve 24 when the cylinder is used in a pushing and pulling form.

In a further exemplary embodiment of the invention as shown in FIG. 4, the sliding piston is in the form of a restricted-orifice piston 50. This means that it rests in a relatively sealing manner on the inner surface 43 of the annular channel 40, but slides in this annular channel.

This restricted orifice piston 50 has an aperture hole 51 in which a restricted orifice 52 is inserted. The restricted orifice 52 is characterized in particular in that it is narrowed in a defined manner to form a very reduced aperture opening 53. In hydraulics, it is known that restricted orifices such as these, particularly when the aperture opening is as short as possible, have the advantage that the flow, for example of oil, is relatively independent of the temperature or the viscosity of the flow medium.

A lower annular edge 54 which interacts with the sphere 36 is interrupted by indentations 55 which ensure that a flow medium can enter the stepped hole 34 and, passing by the helical spring 37, can enter the line 20.

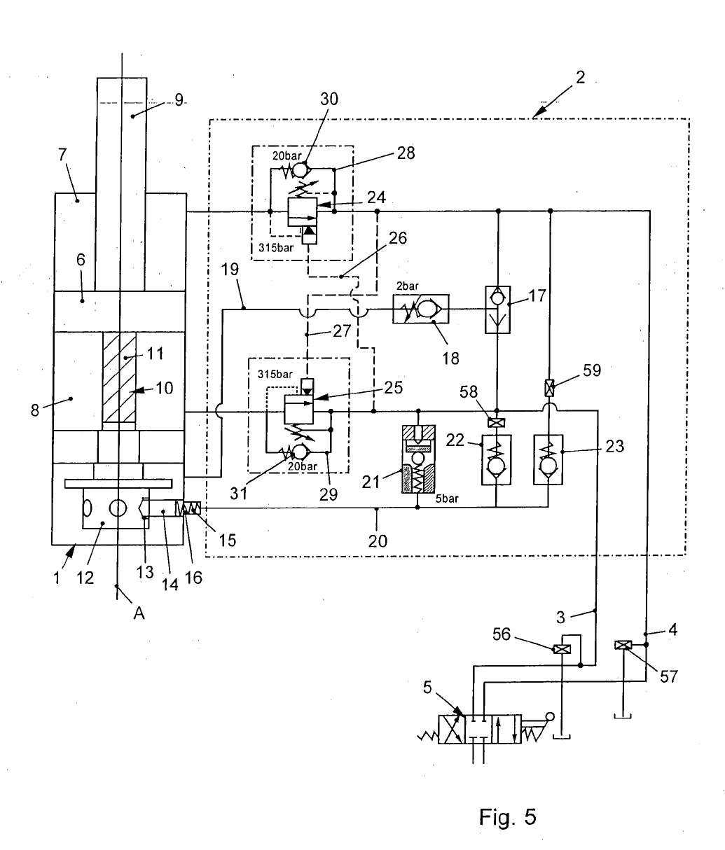

A pressure equalizing valve 21 which is provided with this restricted-orifice piston 50 is used in particular in a hydraulic system as is shown in FIG. 5. This hydraulic system has no pressure control valve 18 and, for this purpose, two restricted orifices 56 and 57 are located in the main line 3 and 4, and can also be integrated in the main valve 5. Two further restricted orifices 58 and 59 are connected upstream of the changeover valve 17 and downstream of the non-return valve 23.

The method of operation of this hydraulic system is as follows:

### Normal Operation

The non-return valves 30 and 31 are now set such that they open even at a very low pressure, specifically of about 0.5 bar. For example, if the aim is to fill the pressure area 8 with a pressure fluid, which means that the working cylinder acts in a pushing form, then the changeover valve 17 is located in the illustrated position and the pressure fluid can enter the pressure area 8 via the main line 3 and via the non-return valve 31. However, the piston 6 does not move since the spindle 10 has not been unlocked. A pressure therefore builds up in the main line 3 and, at about 30 bar, leads to the pressure equalizing valve 21 closing.

Pressure medium flows via the line 19 into the unlocking pressure area 13, until a pressure of about 50 bar is reached there, at which the blocking bolt is forced out of the unlocking pressure area 13 against the force of the helical spring 15, which can be set to be very hard.

However, the piston 6 can still not move since the load-holding valve 24 is in the blocking position. Only when a pressure of about 100 bar has built up in the system is the load-holding valve 24 operated and unlocked via the line 26, such that pressure medium can flow back out of the pressure area 7 through the main line 4 and the main valve 5.

In this preferred hydraulic system, it can be seen that the piston 6 is guided quite deliberately and in a defined manner between the two hydraulic pressure cushions in the pressure areas 8 and 7. The piston 6 is always clamped in between these pressure cushions.

If, in contrast, the aim is to fill the pressure area 7 and thus for the working cylinder to be in a pulling form, then pressure fluid is supplied by moving the main valve 5 to the right into the main line 4. In consequence, the changeover valve 17 switches over, as a result of which the access to the main line 3 is now blocked. In contrast, the main line 4 is connected via the line 19 to the unlocking pressure area 13 upstream of the blocking bolt 14. As soon as the pressure here has also exceeded about 50 bar, the blocking bolt 14 is unlocked against the force of the helical spring 15. However, in this case as well, the piston 6 cannot move until a pressure of about 100 has built up in the line 27 toward the load-holding valve 25, and the load-holding valve 25 is thus switched for fluid to pass through it. Pressure fluid can thus escape from the pressure area 8 via the main line 3 and the main valve 5, which allows the piston to move.

In order to lock the blocking bolt 14 both during pulling and during pushing, the main valve 5 is switched to pass fluid or to the mid-position, in which case the two main lines 3 and 4 have no pressure in them and the pressure medium can flow away into a respective tank via the restricted orifices 56 and 57. Under the pressure of the helical spring 15, the blocking bolt 14 is pushed into the unlocking pressure area 13, and this takes place very quickly. This suppresses rotation of the spindle 10, as a result of which the piston 6 remains secure in this position.

### Disturbances

If the load-holding valve 24 (25) or the non-return valve (30) 31 fails, then, in the event of a slow leakage, as a result of the pressure equalizing valve 21, pressure equalization takes place in the lines 19, 20 and 3. In this case, the force of the helical spring 15 predominates, thus moving the blocking bolt 14 to its locked position.

If the load-holding valve 25 or the non-return valve 31 were to fail completely, then a pressure could also be increased suddenly. In this case, the sudden pressure rise to more than 30 bar results in the restricted-orifice piston 50 being moved downward, as a result of which the sphere 36 is pressed onto the seat 35 and pressure fluid is pumped through the line 20 into the locking pressure area 16. In any case, this pumping effect overcomes the pressure of the pressure fluid in the line 19, so that the blocking bolt 14 remains in the locked position.

As a further malfunction, it would feasible for the helical spring 15 to break before the blocking bolt 14. In this case, the blocking bolt 14 is naturally likewise unlocked, but somewhat more quickly, when the pressure builds up in the line 19. The movement of the piston 6 is, however, still prevented by the blocking which still exists in the load-holding valve 24.

In this case as well, the full system pressure is present in the locking pressure area 16 since there is no impediment to flowing through the pressure equalizing valve 21. In contrast, the restricted orifices 58 and 59 are set with respect to the pressure equalizing valve 21 such that the pressure in the line 20 is always higher, leading to the blocking bolt 14 being closed.

1-22. (canceled)

23. A control system comprising a hydraulic element (14), which moves under the pressure of pressure fluid in a locking pressure area (16) on one side of the hydraulic element (14) into an unlocking pressure area (13) on the other side of the hydraulic element (14), wherein both pressure areas (13, 16) being connected via a respective feed line (19) or (20) to a main line (3, 4), a pressure equalizing valve (21) is connected in the feed line (20) to the locking pressure area (16), which pressure equalizing valve (21) is open on both sides up to a predetermined pressure in the main line (3, 4), but closes the feed line (20) toward the locking pressure area (16) after overcoming this predetermined pressure.

24. The control system as claimed in claim 23, wherein the pressure equalizing valve (21) comprises a sphere (36), which is supported against a spring (37) and has an associated correspondingly shaped spherical seat (35) in an axial stepped hole (34), is inserted into said axial stepped hole (34) in the pressure equalizing valve (21).

25. The control system as claimed in claim 24, wherein a piston (38, 50), which is slidably mounted in the stepped hole (34), presses on the sphere (36) in opposition to the spring (37).

26. The control system as claimed in claim 25, wherein the piston (38) forms an annular area (41) with an inner wall (43) of the stepped hole (34).

27. The control system as claimed in claim 26, wherein the piston (50) has a restricted-orifice (52) located therein.

28. The control system as claimed in claim 23, wherein a pressure control valve (18) is connected in the feed line (19) to the unlocking pressure area (13) and prevents the fluid from flowing back from the unlocking pressure area (13).
